(19) United States
(12) Patent Application Publication
(10) Pub. No.: US 2009/0124238 A1
(43) Pub. Date: May 14, 2009

(54) TELECOMMUNICATIONS SERVICES APPARATUS AND METHODS

(76) Inventor: Jeffrey Wilson, Hants (GB)

Correspondence Address: Vierra Magen Marcus & DeNiro LLP, 575 Market Street, Suite 2500, San Francisco, CA, 94105, US

(21) Appl. No.: 12/158,255

(22) PCT Filed: Dec. 22, 2006
(86) PCT No.: PCT/GB2006/004922

§ 371 Date: Oct. 8, 2008

(30) Foreign Application Priority Data
Dec. 22, 2005 (GB) 0526223.3
Mar. 23, 2006 (GB) 0605876.2
Dec. 22, 2006 (GB) PCT/GB2006/004916

(51) Int. Cl. H04M 3/42

(52) U.S. Cl. 455/414.1

(57) ABSTRACT

A mobile communications system network (2) includes video services equipment (8) that is configured to be able to receive a video call and to record it. A user can set up an association between a virtual mobile number for use to connect to the video call recording video services equipment (8), and an intended recipient delivery email address for a call made using that virtual mobile number. The user can then place a video call to the allocated virtual mobile number to record and send a video message to the indicated delivery email address. The video services equipment (8) prepares the recorded video message as an email attachment and forwards it by email to the indicated deliver email address.

The present invention relates to apparatus and methods for telecommunications services.

The Applicants have recognised that there may be circumstances where a user of a mobile communications terminal wishes to communicate with a third party but may be unable to do so, or may not wish to do so, via the third party's mobile communications terminal.

For example, a user with a video phone may find themselves wishing to make a video call to a user without a video phone, or they may wish to make a video call to the intended recipient but without disturbing the recipient or requiring the recipient to respond. A similar situation could arise in respect of voice calls and/or text messages.

Equally, there may be situations where a user would like to be able to record a voice or video message for themselves for later use, for example for their own enjoyment or records. At the moment mobile communications systems do not normally support such operation, but the Applicants believe that to offer this facility via a user's mobile phone would be desirable and advantageous.

The Applicants believe therefore that there remains scope for improvement to the use of and services available via communications terminals of communications systems.

According to a first aspect of the present invention, there is provided a communications system, comprising:

means for allowing a user of a communications terminal to associate a number that can be dialed with a delivery address to which communication is to be delivered when the number is dialed or used.

According to a second aspect of the present invention, there is provided a method of operating a communications system, the method comprising:

a user of a communications terminal associating a number that can be dialed with a delivery address to which communication is to be delivered when the number is dialed or used.

In the present invention, a user of a communications terminal is able to associate a number to be dialed with a delivery address of their choice (i.e. a selected or desired delivery address), such that when the number is dialed, communications can be delivered to the associated delivery address.

This would firstly allow, for example, a user to associate a number that can be dialed using their communications terminal with a delivery address that may not be directly diallable using a communications terminal (such as, e.g., an email address). This would then allow a user to, for example, use their communications terminal to connect to a given delivery address or intended recipient that may not be directly diallable or “called” using their communications terminal (and, e.g., without the need to try to place a call or message directly to the intended recipient's communications terminal). (Indeed, as will be discussed further below, in a preferred embodiment the delivery address is an address that cannot be dialed directly using a communications terminal.)

The present invention will also allow a user to, for example, associate the number to be dialed with a delivery address that is associated with and/or personal to the user themselves. Such an arrangement could then, as will be discussed further below, be used by the user to send messages using their communications terminal to themselves. (This is in contrast to existing communications systems where a user may be unable to record a message for themselves using their, e.g., mobile phone.)

Thus, the present invention in particular provides, firstly, an arrangement whereby the communication and communication delivery options available via a communications terminal may be increased or enhanced (since a number that can be dialed can be associated with a delivery address that may not be directly “diallable” or “callable” using a communications terminal), and, moreover, provides such an arrangement that is under the control of the “calling” user, i.e. the user who intends to use and dial the number in question. The present invention can accordingly allow individual users and subscribers to establish and exploit associations between numbers to be dialed and corresponding delivery addresses, such that a user can, for example, have their own personal set of numbers to be dialed associated with their own selected, desired delivery addresses.

It should be noted here that in the present invention it is intended that it is the user or caller (the party) who intends to dial or use the number to be dialed who associates the number to be dialed with the delivery address (in contrast, for example, to arrangements in which users expecting to receive calls, etc. (call recipients) can provide a number that can be used to call them). It is a key feature of the present invention that it is the “calling” user who chooses the association between the number to be dialed and its corresponding delivery address.

Thus, in the present invention, the user of the communications terminal associates a number that is for use by (that is to be dialed by) the user of the communications terminal with a (their) desired delivery address. Similarly, the delivery address is an address to which communication is to be delivered when the number is dialed or used by the user (and/or communications terminal) that is performing (establishing) the association.

It is also accordingly the case that in the present invention the associations between numbers that can be dialed and their associated delivery addresses are intended to be and preferably will be personal to the user (and/or communications terminal) who has established the associations. Thus, the association is preferably for and with a delivery address to which communication is to be delivered when the number is used or dialed by the communications terminal (and/or user) requesting the association, and most preferably is for use only in those circumstances, i.e. only when the terminal or user requesting the association dials or uses the number.

Thus, for example, even if two users wish to communicate with the same delivery address (or indeed, have access to the same number that can be dialed, as discussed below), the two users will each establish their own associations between numbers to be dialed and the desired delivery address, rather than sharing a commonly set-up such association.

Thus, according to a third aspect of the present invention, there is provided a communications system in which:

numbers that can be dialed using a communications terminal may be associated with delivery addresses to which communication can be delivered when such a number is dialed or used; and wherein:

a user of a communications terminal who intends to use a number that can be dialed to deliver a communication to an associated delivery address can establish an association between the number that can be dialed and a delivery address for that number.

According to a fourth aspect of the present invention, there is provided a method of operating communications system in which numbers that can be dialed using a communications terminal may be associated with delivery addresses to which communication can be delivered when such a number is dialed or used, the method comprising:

a user of a communications terminal who intends to use a number that can be dialed to deliver a communication to an associated delivery address establishing an association between the number that can be dialed and a delivery address for that number.

According to a fifth aspect of the present invention, there is provided an apparatus for a communications system, in which numbers that can be dialed using a communications terminal may be associated with delivery addresses to which communication can be delivered when such a number is dialed or used, the apparatus comprising:

means for allowing a user of a communications terminal who intends to use a number that can be dialed to deliver a communication to an associated delivery address to establish an association between the number that can be dialed and a delivery address for that number.

The number that can be dialed in the present invention may comprise any suitable such number, i.e. a number that may be dialed and used by a communications terminal of a communications system. Thus it could comprise, and in a preferred embodiment does comprise, a long or short telephone number, or a short-code, etc., as is known in the art. It may be in the form of a numeric or alphanumeric representation, as is known in the art.

In a particularly preferred embodiment, the number that can be dialed comprises a virtual mobile number, such as, and preferably, a virtual mobile long number. The advantage of using a virtual mobile number is that, as is known in the art, this will then allow the number and the connection to the associated delivery address to be operable across different networks (whereas arrangements that only use “standard” numbers or short-codes may only be operable within a single network, i.e. the associating user's home network).

(As is known in the art, “virtual mobile” provides a home location register function for a virtual telephone number, i.e. a number that may be associated with something other than a real physical mobile communications terminal, such as host equipment, such as call recording and storage means, or a computer, etc., on a network. By arranging for a home location register (HLR) function to respond to queries relating to virtual mobile numbers by returning the address of a network node designated for handling the desired virtual mobile function, connection to the virtual mobile function network node is made possible from any network.)

All the numbers that can be dialed could take the same basic form. For example, they could all be virtual mobile numbers. However, there could also be a mixture of such numbers, such as a combination of short codes for on-network use and virtual mobile numbers for use when roaming.

The delivery address that is associated with the number to be dialed may similarly be any suitable and desired such address, such as, for example, an address that will identify a communications node, terminal, or device, etc. As will be appreciated from the above, the delivery address should and preferably does differ from the number that can be dialed that is associated with the delivery address.

Thus the delivery address could, for example, comprise a phone number, such as the phone number of a third party or subscriber of the communications system. In this case, the number to be dialed could, in effect, be used to provide an indirect route for sending a call or message to the phone number in question, since the caller would in this case dial the number to be dialed (e.g. virtual mobile number), rather than the particular phone number (e.g. the subscriber's number) itself, to communicate with the third party (communications terminal) in question.

However, in a preferred embodiment the delivery address comprises an address that cannot be dialed (directly) using a communications terminal, such as an IP (Internet Protocol) or email address. (As discussed above it is an advantage of the invention that it allows a caller to communicate to delivery addresses that are not directly diallable using a communications terminal.)

In a particularly preferred embodiment, the delivery address that is associated with the number that can be dialed comprises an email address. This will allow, as will be discussed further below, the number that can be dialed to be used to direct a communication, such as a voice or video message, to the indicated email address. The Applicants believe that this arrangement is particularly advantageous, because it can facilitate, for example, a user with a video phone being able to send a video message to a third party via email, even if the third party does not themselves own a video phone. It would also, for example, allow a user to direct a message, etc., from their communications terminal to themselves via email.

Thus, in a particularly preferred embodiment, the present invention includes a step of or means for associating a number that can be dialed with an email address (e.g. a selected third party's email address).

In a particularly preferred embodiment, a number that can be dialed can be associated with plural delivery addresses (e.g. email addresses). Thus, it is preferred that a number to be dialed may be associated with a single delivery address, or may be associated with plural delivery addresses.

In one preferred such arrangement, the plural delivery addresses are intended to all be used when the number is dialed, i.e. such that communication is delivered to all of the delivery addresses associated with the dialed number. This would allow, for example, a caller to use a single number to direct communication to multiple delivery addresses (e.g. intended recipients) simultaneously.

It is also preferred that a given number to be dialed may be associated with plural delivery addresses, which delivery addresses are not necessarily intended to be used “simultaneously”, but which delivery addresses are intended to be used in different circumstances. For example, a user may wish to have, for example, voice calls made to the number to be dialed directed to one delivery address, but text messages sent to the same number that can be dialed directed to a second, different delivery address. A user may also, for example, wish to use different delivery addresses at different times of the day or week.

Thus, in a particularly preferred embodiment, a delivery address or delivery addresses that is or are associated with a number that can be dialed preferably can also be associated with one or more than one criteria or conditions indicating when and/or in what circumstances the delivery address is to be used. The criteria used in this regard could, e.g., comprise the time when the number is dialed and/or the communications mode (modality) (e.g. whether it is a voice call, video call, text message, etc.) being used when the number is dialed, etc.

Thus, in a particularly preferred embodiment, where a number that can be dialed can be associated with plural delivery addresses simultaneously, it may further be indicated whether the delivery address or addresses to be used when the number is dialed or used should be selected in accordance with one or more particular, preferably predetermined, criteria, and/or whether some or all of the delivery addresses should be used when the number is dialed or used.

The delivery address or addresses that are associated with the number to be dialed are preferably and typically will be addresses that are associated with or related to a particular, intended recipient or recipients. For example, they could be delivery addresses for a third party or parties known to the user, such as for other subscribers or users of the communications system. It is not essential that the delivery addresses relate to subscribers of the communications system, and they could equally, for example, relate to third parties that are not subscribers of the communications system, and/or, indeed, to users or devices that are outside and/or not directly part of the communications system or network to which the calling user belongs.

Similarly, although in a preferred embodiment the or each delivery address relates to a recipient who is a particular individual, this need not be the case, and a delivery address could relate to or be associated with a group or organisation, or, indeed, a particular system or device, etc., that is associated with or accessible via the communications system.

In one particularly preferred embodiment, the delivery address (or addresses) associated with the number to be dialed can be and preferably is or are related to or associated with the user (caller) who is to dial the number (i.e. who has made the association in the first place). For example, a user could associate the number that can be dialed with their own, e.g., email address. This would then allow a user to use their communications terminal to, e.g., direct or store messages, etc., to themselves, e.g., via email. As discussed above, this is a facility that current communications systems do not support and it is believed by the Applicants to be a particularly advantageous feature of the present invention.

Thus, in a particularly preferred embodiment, the present invention comprises a step of or means for a user of a communications terminal associating a number that can be dialed with a delivery address that can be used to direct communication to the user.

As will be appreciated by those skilled in the art, although the present invention could be used to provide a single user with the ability to associate numbers that can be dialed with desired delivery addresses, it is preferred that this facility is open to plural and preferably to all users who may wish to use it and/or who are permitted to use it. Thus, there will preferably be plural users who have each set-up their own set of associations between numbers that can be dialed and corresponding delivery addresses.

A given “calling” user or communications terminal could have only single number that can be dialed for associating with a desired delivery address. However, in a particularly preferred embodiment, a given user or terminal can have allocated to them a plurality of such numbers (e.g. and preferably, a range of such numbers), and can, preferably, associate each such number with a different delivery address.

In these arrangements, each user could be allocated a different, unique set of numbers. In this case, there would, in effect, be an overall set of numbers that is common to (used by) all users. However, this may require a significant number capacity, depending on how many users are involved.

Thus, in a particularly preferred embodiment there is a set or pool of plural numbers that can be used by plural different users simultaneously (i.e. such that the same number can be used (associated with a delivery address) by different users of the system. Such an arrangement would, in effect, allow the same numbers to be reused as between different users of the system (and to accordingly be in use for different users at the same time), thereby reducing the overall number range that may be required. Thus, in a preferred embodiment, each user has the same set or range of numbers that can be dialed available to them, and plural users will each be able to use the same set or range of numbers that can be dialed.

Such reuse of the numbers that can be associated with delivery addresses can be achieved as desired, but in a particularly preferred embodiment is achieved by associating the relevant number with the user's (the calling (associating) user's) identity (e.g. their CLI (calling line identity)). This would then allow the same number to have different meanings (i.e. to identify different intended delivery addresses) for different callers. In this case, each calling user would, in effect, use the same set of numbers, but those numbers would be allocated independently by the users to their intended delivery addresses, and the meanings of the numbers (i.e. the identity of the associated delivery address) would depend on the caller's identity (i.e. the identity of the user who has associated the number with a delivery address).

Thus, in a particularly preferred embodiment, a number to be used as in the present invention is also associated with the identity of the “associating” (“calling”) user (e.g. with their calling line identity (CLI)), as well as with the delivery address in question.

Thus, according to a sixth aspect of the present invention, there is provided a communications system in which the operator of the system provides a set of one or more numbers that can be dialed and which numbers can be associated with delivery addresses to which communication is to be delivered when the corresponding number is dialed or used, and wherein:

plural different users of communications terminals can set-up their own associations between the numbers in the set of numbers that can be dialed and desired delivery addresses for the numbers.

According to a seventh aspect of the present invention, there is provided a method of operating a communications system in which the operator of the system provides a set of one or more numbers that can be dialed and which numbers can be associated with delivery addresses to which communication is to be delivered when the corresponding number is dialed or used, the method comprising:

plural different users of communications terminals setting-up their own associations between the numbers in the set of numbers that can be dialed and desired delivery addresses for the numbers.

According to an eighth aspect of the present invention, there is provided an apparatus for a communications system in which the operator of the system provides a set of one or more numbers that can be dialed and which numbers can be associated with delivery addresses to which communication is to be delivered when the corresponding number is dialed or used, the apparatus comprising:

means for allocating plural different users of communications terminals to set-up their own associations between the numbers in the set of numbers that can be dialed and desired delivery addresses for the numbers.

As will be appreciated by those skilled in the art, these aspects and embodiments of the invention can and preferably do include any one or more or all of the preferred and optional features of the invention described herein, as appropriate. Thus, for example, the delivery addresses are preferably email addresses, and preferably a set of plural numbers that can be dialed is provided by the operator.

In a preferred embodiment, the present invention further comprises a step of or means for allocating a number or numbers that can be dialed and that are to be associated with delivery addresses to users of communications terminals.

Thus, in a particularly preferred embodiment, the present invention comprises means for or a step of allocating a number that can be dialed to and/or for use by a user of a communications terminal (to or for use by a communications terminal) and allowing the user then to associate the allocated number that can be dialed with a delivery address to which communication is to be delivered when the user (and/or communications terminal) dials or uses the number.

Such allocation of numbers that can be dialed can be done in any suitable and desired fashion. For example, each user, and/or communications terminal, could be allocated, e.g., at manufacture, or when they first become active in the communications network or system, etc., a number or set of numbers for this purpose. In this case, the communications terminal, for example, would have a predetermined set of numbers that are, in effect, permanently allocated to the terminal for this purpose.

In a preferred embodiment, the system can allocate numbers to be dialed to users (and their terminals) in use, e.g., and preferably, on request. This may, for example, be in addition to or instead of a user or terminal also being pre-allocated numbers as discussed above. Thus, in a preferred embodiment, a user can request allocation to himself or herself of a number to be associated by that user with a selected delivery address or addresses.

The association between the number that can be dialed and the desired delivery address or addresses (and, indeed, any request for allocation of a number to use for this purpose) can be carried out and set up in any suitable and desired fashion.

For example, a user could simply inform a system or network operator of the desired association(s) (and request number allocation) at the time their terminal (e.g. phone) is activated.

Similarly, a user could and preferably can call a network or system operator and ask them to associate a number with the desired delivery address or addresses (and, indeed, any criteria or conditions that should be associated with the delivery address(es)) (and, e.g., to first allocate the number). The network operator could then, e.g., record this information in an appropriate database.

It would also be possible to set up the associations, etc., via a computer, e.g., web or Internet-based, interface, or by email.

In a particularly preferred embodiment, the association between a number and its corresponding delivery address(es) can be, and is preferably, achieved by sending or exchanging a short message, e.g., and preferably a text message (e.g. an SMS message), or messages, to or with the communications system, for example, and preferably, to request a number (if required) and to inform the system of the intended delivery address(es), conditions, etc. (if required) that the number is to be associated with.

It is preferred that the association, etc., process occurs in an automated fashion, e.g., via communication with an automated control system of the communications system. This can be achieved in any suitable and desired manner. For example, in the case of the use of short messages, such as text messages, the, e.g., text, message could include the relevant delivery address information, etc., as part of its content, for example in a predefined syntax that specifies the relevant information. In the case of a voice or video call, an automated speech recognition process could be used to determine the relevant information from the call, and/or automated DTMF detection could, e.g., be used to transmit the necessary predefined character coding to specify the delivery address(es), etc., if desired. It would also be possible, e.g., to use an automated Internet (web)-based system to carry out the associating process, etc.

Thus, in a particularly preferred embodiment, the present invention comprises a step of or means for the user and/or a communications terminal informing the communications network of the desired association between a number and a delivery address (or addresses).

Preferably the allocations and associations of the numbers can be queried and changed in use, e.g., upon request of a user. It is also preferably possible for a user to be able to query the system, e.g. to ascertain how many numbers they have available, and/or what numbers they have associated with which delivery addresses.

As will be appreciated from the above, in the present invention, the system should and will store a set of, and/or have access to a stored set of, associations between the numbers that can be dialed and their corresponding delivery addresses. Most preferably (as discussed above) associations between the numbers and callers' (a calling users') identities are also stored.

Thus, according to a ninth aspect of the present invention, there is provided a communications system, comprising:

means in or accessible via the communications system infrastructure for storing associations between numbers that can be dialed and delivery addresses to which communication is to be delivered when the numbers are dialed or used.

According to a tenth aspect of the present invention, there is provided a method of operating a communications system, the method comprising:

storing in or accessible via the communications system infrastructure associations between numbers that can be dialed and delivery addresses to which communication is to be delivered when the numbers are dialed or used.

As will be appreciated by those skilled in the art, these aspects and embodiments of the invention can and preferably do include any one or more or all of the preferred and optional features of the invention described herein. Thus, for example, the numbers that can be dialed are preferably stored in association with a user's calling identity (e.g. their CLI), as discussed above, so that the numbers can be re-used by different users.

It is, as discussed above, preferred that plural different delivery address associations for a given number that can be dialed can be and preferably are stored simultaneously. This would be the case where, as discussed above, the numbers that can be dialed can be reused as between different calling users of the system. Thus, in such an arrangement each association is preferably associated with a different user who is to dial (use) the number. Thus, most preferably, there is a set of numbers that can be dialed and, preferably, plural different sets of associations with delivery addresses are stored for the set of numbers simultaneously.

It is also accordingly preferred in these arrangements and aspects of the invention that the associations between delivery addresses and numbers that can be dialed are stored in response to requests for such associations to be set up from users of communications terminals.

Thus, in a particularly preferred embodiment, the system infrastructure is operable to and includes means for receiving from a communications terminal a request to associate a number that can be dialed with a delivery address to which communication is to be delivered when the number is dialed or used, and then storing the requested association.

Thus, according to an eleventh aspect of the present invention, there is provided a communications system infrastructure, comprising:

means for receiving from a communications terminal a request to associate a number that can be dialed with a delivery address to which communication is to be delivered when the number is dialed or used; and

means for storing, in response to the request, the requested association between the number and the delivery address.

According to a twelfth aspect of the present invention, there is provided a method of operating a communications system, the method comprising:

a communications terminal sending to the system infrastructure a request to associate a number that can be dialed with a delivery address to which communication is to be delivered when the number is dialed or used; and

the system infrastructure, in response to the request, storing the requested association between the number and the delivery address.

Again, as will be appreciated by those skilled in the art, these aspects and embodiments of the invention can and preferably do include any one or more or all of the preferred and optional features of the invention described herein. Thus, for example, the request from the communications terminal can, e.g., be made via a voice call, but is preferably made via a short message, e.g., and preferably, via a text message. Similarly, the delivery address is preferably an email address, and the number preferably may be associated with plural delivery addresses simultaneously.

It is also accordingly preferred that the requested association between the number that can be dialed and the delivery address(es) is for the use of (and preferably personal to) the requesting communications terminal (the user of that terminal). Thus, the association is preferably for and with a delivery address to which communication is to be delivered when the number is used or dialed by the communications terminal (and/or user) requesting the association, and most preferably is for use only in those circumstances, i.e. only when the terminal or user requesting the association dials or uses the number.

The record of the associations between numbers that can be dialed and their corresponding delivery addresses can be maintained in or for the system infrastructure in any suitable and desired fashion. Thus, there is preferably one or more databases or controllers, etc., in or accessible by the system infrastructure that maintain these records. As discussed above, the number(s) that can be dialed are preferably stored in association with the requesting user's (communications terminal's) identity (e.g. CLI)), as well as in association with the delivery address(es) in question.

In a preferred embodiment, a user can query the network to determine the delivery address associated with a given number.

A user can preferably store the or each number to be dialed that they have been allocated in their communications terminal, e.g. and preferably, in the phonebook of their communications terminal, so that they then have the number to be dialed readily available for use for sending a message, etc., to the associated delivery address. The user could and preferably can in this regard enter an appropriate name or label for the number to be dialed, e.g., identifying the associated delivery address, in their, e.g., phonebook, so that they can more readily identify the purpose of the number.

Thus a user may, e.g., make an entry for “Joe Bloggs' email” in their phonebook against a number to be dialed that they have associated with “Joe Bloggs'” email address as a delivery address. This would then allow the user to readily display on their terminal and select on their terminal the number to be dialed to, e.g., deliver a message by email to Joe Bloggs' email address.

As will be appreciated by those skilled in the art, and as discussed above, the association between the delivery address and the number that can be dialed is intended to allow the number to then be used to direct communication, such as a voice, video or text message, to the delivery address in question. The association between the number and the delivery address can be configured in any suitable and desired way to achieve this. For example, the number to be dialed could be stored together with the full delivery address. Alternatively, for example, the number could be associated with (stored in association with) an identifier and/or pointer for the delivery address, which identifier and/or pointer the system can then use to, e.g., retrieve the delivery address from another location (store).

Once a user has associated a number for them to dial with a delivery address, then in use of the system of the present invention, as discussed above, the user should be able to dial the number that they have associated with the delivery address and the system then operate so as to deliver or direct communication to the associated delivery address.

Thus, in a preferred embodiment, the communications system (e.g. and preferably the communications system infrastructure) can and will in use recognise the use of a number that has been associated with a delivery address or addresses, and can and will in response to the use of the number, direct or deliver communication to the delivery address accordingly.

Such operation can be provided as desired in the communications system. However, in a preferred embodiment there is particular device or system in or accessible via the communications system network (infrastructure), such as, and preferably, a suitable mobile services equipment or platform, which is operable to cause the delivery of communication to the appropriate delivery address(es) when the number is dialed or used.

In other words, the numbers that may be used and associated with delivery addresses in the manner of the present invention preferably connect the caller (the user of the number) to a device or system, such as mobile services equipment, etc., in or accessible via the system infrastructure that is then operable to direct or deliver communication to the delivery address or addresses that is associated with the dialed number. This system, e.g., mobile services equipment, accordingly preferably itself stores or at least has access to, the associations between the numbers that can be dialed and their corresponding delivery addresses (and the dialing user's (caller's) identity, where appropriate).

The communication can be delivered to the delivery address or addresses associated with the number that has been dialed in any suitable and desired fashion. For example, the dialing of the number could cause a communications connection to be established at the time to the delivery address or addresses. This could be the case, for example, where the delivery address relates to a call recording device. In this case the user would then be connected to the delivery address and thereby deliver their communication to the delivery address.

However, in a particularly preferred embodiment, a “live” or direct connection between the delivery address(es) and the communications terminal is not established when the number is dialed, but instead, communication is delivered to the delivery address(es) after the communication dialed using the number has finished (ceased). In this case, the user dialing the number will, in effect, be connected to an intermediate node or system, rather than the delivery address(es) itself, with communication being delivered to the delivery address(es) thereafter.

Thus, in a preferred embodiment, dialing or using the number that can be dialed does not cause a connection to the delivery address(es) associated with the number, but instead connects the dialing caller (user) to another device or system, which device or system is then operable to deliver a or the communication to the associated delivery address (either simultaneously, but preferably thereafter (i.e. after the communication using the dialed number has ceased)).

In these arrangements, where dialing the number connects to an intermediate node or device in the system, then that node or device preferably acts to record and/or store the communication made using the dialed number (and to then, e.g. and preferably, subsequently cause that communication to be delivered to the appropriate delivery address(es)). Thus, for example, in the case of a voice or video call, the intermediate node or device preferably operates to record and store the call (at least the calling side of the call) for delivery to the delivery address(es). In the case of a short message, such as a text (e.g. SMS) or MMS message, it preferably receives and stores the message for delivery to the delivery address(es).

Thus, in a preferred embodiment, the use or dialing of a number that is associated with a delivery address connects the caller (user) to a recording and storage arrangement (e.g. and preferably in or accessible via the network infrastructure) for voice and/or video calls and/or text messages, etc., made or sent using the number. Such arrangements will allow, for example, a user to use the number that is associated with a delivery address to send messages (e.g. voice, video or text) to the delivery address (e.g. desired third parties or, indeed, to themselves).

In these arrangements, where a call, etc., is to be recorded for then providing to the delivery address associated with the number that has been dialed, it is preferred that at least the calling side of the call made to the number is recorded. In a preferred embodiment, the audio signal for the other side (non-calling direction) can be and preferably is recorded as well. Thus, in one preferred embodiment the audio signal from both sides of the call is recorded (summed). This would allow the recorded call to also playback the content of, e.g., any outgoing announcements, beeps, etc., broadcast to the caller as the call is recorded.

The recording means can also accordingly preferably act as a suitable call “termination”, i.e. so that the caller's terminal can operate as though a “normal” call is being made (and will stay connected to the recording means during the call).

In these arrangements, the stored recorded calls or messages are preferably associated with (e.g. stored in association with) a suitable identifier for the intended delivery address or addresses to which they are to be delivered (e.g. with the delivery address(es) themselves), so as to facilitate provision of the stored message to the intended delivery address.

Once a recorded call or message has been stored in this manner, then it can be delivered to the appropriate delivery address(es) in any desired manner.

In a particularly preferred embodiment, the recorded call or message can and preferably is itself delivered to the associated delivery address or addresses, rather than, e.g., a third party, etc., needing to collect or retrieve the message-themselves. In other words, the communication that is made to the delivery address preferably comprises the communication (e.g. call or message) that is made when the number is dialed or called. Thus, in a preferred embodiment, a recorded or stored message can be and preferably is delivered automatically to the indicated delivery address(es) (i.e. the delivery address(es) that have been (previously) associated with the number that was dialed to leave the message). (It should again, however, be noted here that in these arrangements, there still may not be and there preferably is not any direct, “live” connection between the calling user and the end delivery address when the call or message is made or sent by dialing the number that can be dialed.)

In such arrangements, the recorded or stored message can be sent to the delivery address or addresses in any suitable and desired form.

In one particularly preferred embodiment, the recorded or stored message is sent by email to the delivery address or addresses (in which case, the delivery address or addresses that is or are associated with the number that can be dialed preferably comprise an email address or addresses, as discussed above). In this case, the system, e.g. the recording and storage means, is preferably operable to convert the recorded call, received message, etc., to a format suitable for sending via email and to then deliver the message, etc., to the indicated delivery address by email. Most preferably the recorded call, received message, etc., is prepared as (converted to) a suitable email attachment and then forwarded by email to the email addressees) associated with the number that was dialed.

Thus, in a preferred embodiment, the communication is delivered to the delivery address in an appropriate form (and preferably, e.g., by email) as and/or, preferably, after, the communication has been made to the number that can be dialed that is associated with the delivery address.

Thus, in a particularly preferred embodiment, in particular where, as discussed above, the number that can be dialed is or can be associated with an email address, the arrangement is such that dialing the number connects the calling user to an arrangement for recording or receiving a message from the caller and then forwarding that message by email to an or the email address or addresses associated with the number that was dialed.

It is believed that an arrangement for allowing a user to configure a number to allow calls or messages, etc., to be forwarded by email is new and advantageous in its own right.

Thus, according to a thirteenth aspect of the present invention, there is provided a communications system, comprising:

means for allowing a user of a communications terminal to associate an email address with a number that can dialed; and

means for enabling a call or message that is made or sent to the number that has been associated with the email address to be delivered by email to the email address that has been associated with the number.

According to a fourteenth aspect of the present invention, there is provided a method of operating a communications system, the method comprising:

a user of a communications terminal associating an email address with a number that can be dialed; and

the system infrastructure delivering a call or message that is made or sent to the number that has been associated with an email address by email to the email address that has been associated with the number.

As will be appreciated by those skilled in the art, these aspects and embodiments of the invention can and preferably do include any one or more or all of the preferred and optional features of the invention described herein, as appropriate. Thus, for example, the number can preferably be associated with plural email addresses, if desired, and the message is preferably a video message.

The communications connection that can be made or attempted using the numbers that can be dialed to be used in the present invention can take any suitable and desired form. Thus, for example, the numbers can preferably be dialed or used to make voice calls, video calls and/or to send short messages, such as text or MMS messages, and preferably can be used with any one or more or all of these communication forms (modes). In other words, the numbers that can be dialed are preferably capable of receiving one or more and preferably plural forms of communications modality (modes).

In other words, it is preferred that communication to be delivered to the delivery address can comprise any one or more or all of a voice call, a video call, or a short message, etc. This said, it would, of course, be possible to have a more restricted arrangement, where, e.g., only a voice or video call or a short (e.g. text) message can be made or sent using the number that can be dialed, if desired. Indeed, in one preferred embodiment, only a voice and/or video call can be made or sent using the number that can be dialed.

It should accordingly also be noted that references herein to the “caller” or “calling user”, etc., are intended, unless the context requires otherwise, to refer to the user or party who dials or uses the number that can be dialed for whatever purpose (e.g. whether to make a voice or video call, or to send a text message), and not necessarily just to “true” bidirectional voice or video “calls”. Similar comments apply to the use of the word “call”. Thus, for example, references herein to a “call” being made to a number, etc., associated with a delivery address, etc., are intended to encompass both unidirectional and bidirectional (and multidirectional) communication, unless the context requires otherwise.

Similarly, references herein to connecting or attempting to connect a call, etc., are intended, unless the context otherwise requires, to refer to the system directing the call to the appropriate termination (end point) and do not necessarily require a successful call connection to ultimately be established.

As will be appreciated from the above, the present invention in its preferred embodiments at least provides an arrangement whereby a caller can direct an e.g., video (or other) message to a third party without the need for any action by or co-operation from the intended recipient third party. In other words the delivery of the video message, etc., can be and is entirely under the control of, and at the behest of, the calling user. Similarly, the arrangement permits such messages to be sent to intended recipients who do not in themselves have or wish to, use a video phone.

The Applicants consider these features of the present invention to be particularly advantageous and believe that such arrangements are new and advantageous in their own right.

Thus, according to a further aspect of the present invention, there is provided a communications system comprising means for allowing a user of a video phone to send a video message to an intended recipient without the intended recipient needing themselves to have a video phone.

According to another aspect of the present invention, there is provided a method of operating a communications system comprising a user of a video phone sending a video message to an intended recipient without the intended recipient needing themselves to have a video phone.

According to a yet further aspect of the present invention, there is provided a communications system comprising means for allowing a user of a video phone to send a video message to an intended recipient independently of any action or co-operation by the intended recipient.

According to a yet further aspect of the present invention, there is provided a method of operating a communications system comprising a user of a video phone sending a video message to an intended recipient independently of any action or co-operation by the intended recipient.

As will be appreciated by those skilled in the art, these aspects of the invention can and preferably do include any one or more or all of the preferred and optional features of the invention described herein, as appropriate.

Thus, for example, in one preferred embodiment, the arrangement is such that a user can associate a number that can be dialed with a delivery address for the video message. Similarly, the arrangement can preferably also or instead be used for other forms of communications, such as voice calls or short (e.g. text) messages.

The Applicants have recognised that it would also be possible for similar effects to be achieved by means of, for example, a system of or accessible via the system infrastructure dialing “out” to (calling) a user (the user's communications terminal) who is to leave a message and inviting the user to leave a message, with the message then being recorded and delivered to the intended recipient, e.g., in the manner or manners discussed above. In this case, rather than the calling user dialing a number that, e.g., connects to the message recording means, the user may, e.g., ask the system to call him or her (his or her communications terminal) for the purpose of recording a message (e.g. by sending a text message requesting such a “call”). In this case, the process and, e.g., the identity of the intended recipient could, e.g., be set up via a text message exchange, or the Internet, etc.

It will be appreciated that in such an arrangement where the system “calls” out to the user for the user then to leave a message for an intended recipient, then it may not, strictly speaking, be the calling side of the call that is recorded, but will be at least the “called” or receiver's side of the call that is recorded.

Thus, according to a yet further aspect of the present invention, there is provided a method of operating a communications system which comprises a message recording system, device or means in or accessible via the system infrastructure, the method comprising:

placing a call to a user to connect the user to the message recording system or device or means; and

the message recording system or device or means recording at least a part of the call for provision to an intended recipient.

According to a yet further aspect of the present invention, there is provided a communications system, comprising:

a message recording system or device or means in or accessible via the system infrastructure;

means for placing a call to a user to connect the user to the message recording system or device or means; and

means for controlling the message recording system or device or means to record at least a part of the call for provision to an intended recipient.

As will be appreciated by those skilled in the art, these aspects and embodiments of the invention can and preferably do include any one or more or all of the preferred and optional features of the invention described herein, as appropriate.

Thus, for example, the user leaving the message can preferably indicate to the system a desired intended recipient and/or delivery address for the recorded message, e.g., and preferably, by sending or exchanging a text message or messages with the system. Similarly, the recorded message can preferably be delivered by email to the intended recipient and/or delivery address, and the message may, e.g., be (part of a) a recorded voice or video call, or a text message, etc.

In these arrangements, the user can preferably request that the system calls him or her for the purpose of leaving a message, e.g., and preferably, by sending a text message to, e.g., a suitable controller of the system. (This could also be done, e.g., by the user first calling an operator and/or via a web-based arrangement, etc.).

It will be appreciated that in these arrangements and aspects of the invention, the delivery address for the communication (e.g. message) may not, strictly speaking, be associated with a number that can be dialed, but rather may be associated with a communications connection that is established by the system calling the user who is to leave the message. It will also be appreciated that where a number to be dialed is associated with the delivery address, that still associates a communications connection with the delivery address.

Thus, according to a further aspect of the present invention, there is provided a communications system, comprising:

means for allowing a user of a communications terminal to associate a communications connection that can be established with a delivery address to which communication is to be delivered when the communications connection is established.

According to a further aspect of the present invention, there is provided a method of operating a communications system, the method comprising:

a user of a communications terminal associating a communications connection that can be established with a delivery address to which communication is to be delivered when the communications connection is established.

According to a further aspect of the present invention, there is provided a communications system in which:

communications connections that can be established with a communications terminal may be associated with delivery addresses to which communication can be delivered when such a communications connection is established; and wherein:

a user of a communications terminal who intends to use a communications connection that can be established to deliver a communication to an associated delivery address can establish an association between the communications connection that can be established and a delivery address for that communications connection.

According to a further aspect of the present invention, there is provided a method of operating communications system in which communications connections that can be established with a communications terminal may be associated with delivery addresses to which communication can be delivered when such a communications connection is established, the method comprising:

a user of a communications terminal who intends to use a communications connection that can be established to deliver a communication to an associated delivery address establishing an association between the communications connection that can be established and a delivery address for that communications connection.

According to a further aspect of the present invention, there is provided an apparatus for a communications system, in which communications connections that can be established with a communications terminal may be associated with delivery addresses to which communication can be delivered when such a communications connection is established, the apparatus comprising:

means for allowing a user of a communications terminal who intends to use a communications connection that can be established to deliver a communication to an associated delivery address to establish an association between the communications connection that can be established and a delivery address for that communications connection.

As will be appreciated by those skilled in the art, these aspects and embodiments of the invention can and preferably do include any one or more or all of the preferred and optional features of the invention described herein, as appropriate.

Thus, for example, in a preferred embodiment the communications connection is established by the user dialing a number that can be dialed, and in that case it is a number that can be dialed that is associated with the corresponding delivery address.

Equally, in another preferred embodiment, the communications connection that can be established can instead or also be established by the system calling the user, as discussed above. In this case where the communications connection is established by the system calling or connecting to the user who is to send the message, etc., then all of the preferred and optional arrangements described above in relation to an arrangement where the user dials a number to deliver communication to the delivery address can equally be used, as appropriate.

Similarly, in a preferred embodiment these aspects and arrangements comprise a step of or means for a user making a request to associate a communications connection that can established with the delivery address to which a communication is to be delivered when the communications connection is established, and, preferably, the system then storing in response to that request, the requested association between the communications connection and the delivery address.

It is also accordingly preferred that the delivery address is an email address, and/or that the communications connection to be established can be associated with plural delivery addresses, etc.

The communications terminal or terminals in the present invention can take any suitable and desired form. In a preferred embodiment they comprise a portable or mobile terminal, and most preferably a mobile phone handset, as it is envisaged that the present invention has particular utility for users of portable devices, such as mobile phones.

The user may also be any desired and suitable party. For example, they are preferably a subscriber of the communications system that allocates the numbers that can be dialed, etc., but this need not necessarily be the case.

As will be appreciated by those skilled in the art, in use of the present invention, the network infrastructure will need to, for example, store and keep track of call recordings and/or messages, intended delivery addresses, and numbers that can be dialed, etc. Thus, in a preferred embodiment, the network infrastructure comprises a controller or controllers that can carry out one or more and preferably all of these functions and that is preferably associated with the call or message recording and storage means on the network (where provided).

The present invention can be applied in any suitable telecommunications system and network. It is particularly, but not exclusively, suited to mobile communications networks, such as GSM and 3G networks, and thus in a preferred embodiment, the communications system includes a mobile communications system. The invention can also be applied to and used in fixed networks, for example by using fixed network virtual numbers. In a preferred embodiment the communication system comprises (solely) a mobile communications system.

It should also be noted here that the various components of the system may be distributed across a network or networks, and there may be duplicate sets of components if desired. Equally, the system may be operable across a plurality of different networks (networks of different service providers and/or countries, etc.) and preferably can support and be used by communications terminals that have roamed to foreign networks (as discussed above, the use of virtual mobile numbers can facilitate operation with roaming mobile terminals).

As will be appreciated by those skilled in the art, all of the aspects and embodiments of the invention described herein may and preferably do include any one or more or all of the preferred and optional features of the invention described herein, as appropriate.

The methods in accordance with the present invention may be implemented at least partially using software e.g. computer programs. It will thus be seen that when viewed from further aspects the present invention provides computer software specifically adapted to carry out the methods herein described when installed on data processing means, a computer program element comprising computer software code portions for performing the methods herein described when the program element is run on data processing means, and a computer program comprising code means adapted to perform all the steps of a method or of the methods herein described when the program is run on a data-processing system. The invention also extends to a computer software carrier comprising such software which when used to operate a communications system and/or terminal comprising data processing means causes in conjunction with said data processing means said system or terminal to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A preferred embodiment of the present invention will now be described by way of example only and with reference to the accompanying drawing,

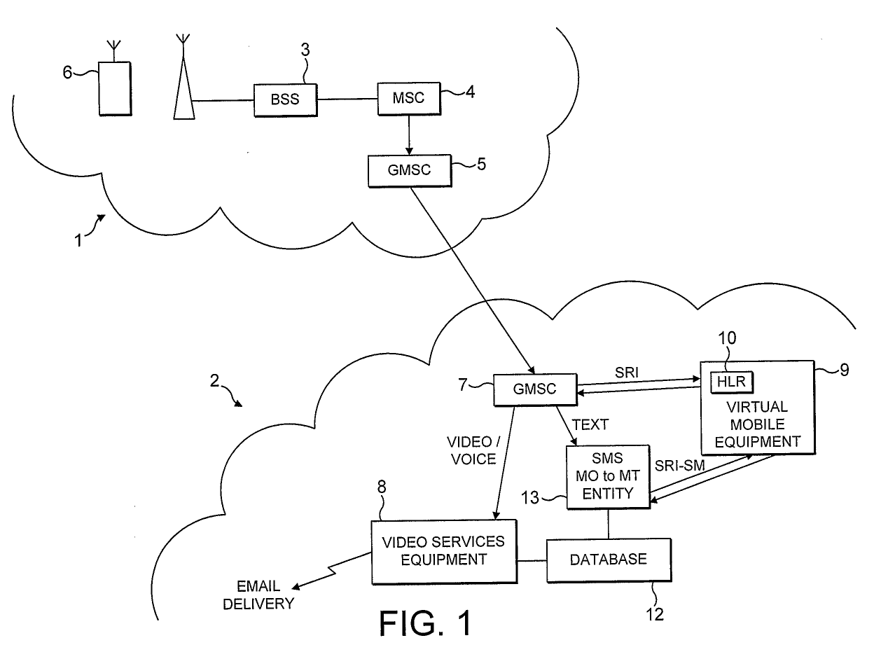

FIG. 1, which shows schematically an embodiment of a mobile communications system that may be operated in accordance with the present invention.

In the mobile communications system shown in FIG. 1, there is a first communications network 1 which for the purpose of the present embodiment can be considered to be a roaming network, and a second communications network 2, which for the purpose of the present embodiment can be considered to be the home network.

As will be appreciated by those skilled in the art, the networks 1 and 2 may in practice be the same network, or they could be different networks.

Network 1 includes, as is known in the art, a base station subsystem (BSS) 3 which is connected to a mobile switching centre (MSC) 4 which is then connected to a gateway mobile switching centre (GMSC) 5. Calls from a calling mobile station (the sender) 6 are routed via these components to the dialed destination number, as is known in the art.

Network 2 similarly includes a gateway mobile switching centre 7 for routing calls to and from that network.

Network 2 will also include suitable base station subsystems, mobile switching centres, etc., as is known in the art. (These components are not shown so as to simplify the FIGURE. Indeed, as will be appreciated by those skilled in the art, the networks 1 and 2 may and will include other components and functions that are standard or common to such networks, such as home location registers, short message switching centres, SMS routers, etc. These components are not shown in order to simplify the FIGURE.)

As shown in FIG. 1, network 2 also includes means for recording the calling side of a video call in the form of video services equipment 8.

The video services equipment 8 is configured to be able to receive a video call and to record it.

As shown in FIG. 1, the network 2 also includes a database 12.

Virtual mobile numbers are used to connect calls to the video services equipment 8 in the usual way. Thus, the network 2 includes virtual mobile equipment 9 that maintains the list of virtual mobile numbers that are associated with the video services equipment 8, and that operate to direct a call directed to one of the virtual mobile numbers associated with the video services equipment 8 to the video services equipment 8.

To facilitate this, virtual mobile equipment 9 maintains, as shown in FIG. 1, its own home location register (HLR) 10. This is possible since the video services equipment 8 is fixed and will not move. However, alternative arrangements, such as the location update home location register technique or any other suitable method for implementing virtual mobile numbers could be used instead, if desired.

A call made to a virtual mobile number associated with the video services equipment 8 is connected thereto using conventional virtual mobile number techniques.

Thus, for example, if the caller 6 dials a virtual mobile number associated with the video services equipment 8, the video call is routed by the base station subsystem 3, mobile switching centre 4 and gateway mobile switching centre 5 of the caller's network 1 to the gateway mobile switching centre 7 of the network 2 that includes the video services equipment 8. The gateway mobile switching centre 7 of the network 2 will then send a send routing information (SRI) query to the virtual mobile equipment 9. The home location register 10 of the virtual mobile equipment 9 will then return the routing information for the video services equipment 8 to the gateway mobile switching centre 7. The gateway mobile switching centre 7 will then proceed using the provided routing information to connect the video call to the video services equipment 8.

When the video call is connected to the video services equipment 8, the caller receives a video announcement inviting them to start leaving their message. The video services equipment 8 then records the calling side of the call. The back channel to the sender's handset 2 is used to send an appropriate return signal to keep the sender's handset connected and “happy”. This return signal could be used, e.g., for advertising or for conveying information to the caller about the progress of the call (e.g. how long he or she has recorded). Once the call is recorded, the caller is offered the opportunity to review, re-record or abandon the recorded call (message).

In the present embodiment, there is a pool of plural virtual mobile numbers for use to connect to the video services equipment 8. A user can set up an association between a virtual mobile number and an intended recipient delivery address for a call made to or using that virtual mobile number, which delivery address is in the present embodiment in the form of an email address to which the recorded video call should be sent. Once such an association has been set up, the user can then, e.g., store in their phonebook on their handset a virtual mobile number which they can then dial to record a video call for forwarding by email to the intended recipient (the delivery (email) address they have associated with the virtual mobile number).

In this embodiment, the association of a virtual mobile number with an intended delivery (recipient) email address is performed by means of an SMS message exchange with the database 12.

For example, the requesting user could send a text message to the database 12 (to a short code or virtual mobile number associated with the database 12) containing the email address, e.g., joebloggs@another.com, of the recipient that they wish to set up a video call recording service for The database 12 would then return to the caller a text message which includes the virtual mobile number to use to send video messages to the email address joebloggs@another.com. This message could, for example, read “save +44 7797835926 in your phonebook, and call it to send a video message to joebloggs@another.com”. The requesting caller can then save the allocated number from the text message in their phonebook together with an indication that it is for sending video messages to the email address joebloggs@another.com.

As shown in FIG. 1, the text messages exchanged with the database 12 proceed via a suitable SMS (text) message “MO to MT entity” 13. As is known in the art, this entity operates to route the text messages correctly, and to convert them as appropriate from mobile-originated (MO) form to mobile-terminated (MT) form, and vice-versa.

The database 12 stores the intended delivery email address received from the user in association with the allocated virtual mobile number and the original caller's identity (number), so that the system then has stored an association between the original caller, the allocated virtual mobile number, and the intended delivery email address. This enables the intended recipient email address to be retrieved and used when the caller records a video message via the video services equipment 8 using the allocated virtual mobile number.

As the association between a virtual mobile number for connecting to the video services equipment 8 and the intended recipient email address is also associated with the requesting caller's identity (the caller's number), the association between the virtual mobile number for connecting to the video services equipment 8 and the intended recipient email address is personal to that particular caller (user) (i.e. only applies to calls made by that caller as identified by his or her, e.g., calling line identification (CLI)). This means that the same virtual mobile numbers may be reused by other users for connecting to the video services equipment 8. (In order to facilitate this, if a user withholds their CLI on a call, the system will not operate for that call, and the call will be cleared after an error message has been transmitted.)

An association set up by a user is maintained indefinitely, until the particular user chooses to delete it.

It is also possible for a caller to query the database 12, for example in order to ascertain the number of remaining free virtual mobile numbers, to check the recipient email address allocated to a particular virtual mobile number, or to delete (free-up) a particular virtual mobile number. Again, these queries and message exchanges are preferably carried out by means of appropriate SMS message exchanges with the database 12.

Other arrangements for allocating virtual mobile numbers to users and associating them with an intended recipient email address can be used, if desired. For example, a user could call a network operator, or use an Internet-based service, to do this.

Once a virtual mobile number for connecting to the video call recording video services equipment 8 has been allocated to a user and associated with an intended recipient email address, the caller can then place a video call to the allocated virtual mobile number to record and send a video message to the indicated delivery email address.

As discussed above, when the caller dials the virtual mobile number, the virtual mobile equipment 9 will cause the call to be connected to the video services equipment 8. The caller then receives a prompt (such as “please leave your message after the tone”) to record a video message, and the video services equipment 8 then records the message (the calling side of the video call).

Once the call is ended, the recorded call (message) is stored in a file and the virtual mobile number dialed by the caller, together with the caller's identity (which is derived from their CLI (calling line identity)), is used to retrieve the intended recipient email address which has previously been associated with the caller and virtual mobile number in question from the database 12.

The video services equipment 8 then prepares the recorded video message as an email attachment and forwards it by email to the indicated delivery email address.

As will be appreciated by those skilled in the art, the above embodiments of the present invention can be modified and/or varied if and as desired.

For example, the system could be configured to enable a user to define plural intended recipient email addresses. For example, rather than a caller associating a given virtual mobile number for connecting to the video service equipment 8 with a single intended recipient, the caller could indicate a plurality of intended recipient email addresses via an appropriate messaging arrangement. Then when a message is recorded using that virtual mobile number, the controller 12 will be able to identify that a group of delivery email addresses has been indicated, and then, e.g., forward the message by email to each of those delivery email addresses.

Also, as well as a recorded video call being delivered as an email attachment, it could be retrievable by the intended recipient using their videophone, or other delivery options and formats could be provided as well. Equally, the virtual mobile number may, e.g., be associated with some other identifier for the intended recipient, rather than an email address, such as their phone number (and in this case, the recorded message could, e.g., be delivered to their phone, instead).

Similarly, the video services equipment 8 is preferably also or instead configured to operate in a similar manner for voice calls and/or text messages that are directed to it (e.g. sent using a virtual mobile number associated with the video services equipment 8), for example to record them and provide them as emails, etc., to the identified intended delivery address. This would then allow, for example, a user to use a single number to forward video, voice and/or text messages to a given recipient email address.

Although the above embodiments have been described with reference to the routing of the video calls via existing GSM routing techniques, as will be appreciated by those skilled in the art, a similar arrangement can be used for future 3G networks where, for example, video calls and data may be carried over IP and the Internet packets routed via media gateways. In this case the call could be set up and follow, for example, the appropriate specification for voice-over IP (VoIP) and session initiation protocol (SIP) signalling produced by the IETF (Internet Engineering Task Force).

Similarly, although the present embodiment has been described with particular reference to the use of virtual mobile numbers, it could be implemented using short-codes or other numbers (e.g. for on-network use), if desired. It would also be possible by addition of a suitable infrastructure to a fixed network to implement the techniques of the present invention for fixed network virtual numbers, etc.

It can be seen from the above that the present invention, in its preferred embodiments at least, allows a caller to associate a delivery address, such as an email address, with a number that can be dialed, such that the caller can then, e.g., direct a voice or video call or short message to the number and have it delivered, e.g., by email, to the associated delivery address.

This provides a particularly convenient and efficient mechanism for sending messages, such as a video message, to a recipient who, for example, doesn't have a video phone, or may have a video phone but doesn't want to be disturbed, or may have a video phone but would prefer to use email reception of the video message (e.g. for cost or archiving reasons), or may be out of coverage of a video mobile signal, or, indeed, to one's self, using a mobile phone.

The present invention also allows the choice of sending a message rather than making a full two-way call to be the choice of the sender. For example, and in particular, it enables a caller to send a video message to one or more recipients who don't have video phones.

It will also be appreciated from the above that service embodying the present invention is straightforward for a user to set up and use. It can be implemented on existing handsets without modification and can therefore very easily be provided to a large number of users.

1.-31. (canceled)

32. A communications system, comprising:
a database system that stores associations between numbers that can be dialed using a communications terminal to establish a communications connection and delivery addresses to which communication is to be delivered when such a number is dialed or used;
the database system includes a controller that allows a user of the communications terminal who intends to use a particular number of the numbers that can be dialed to establish a communications connection to deliver a communication to an associated delivery address to establish an association between the particular number and the associated delivery address.

33. The communications system of claim 32, wherein:
an operator of the communication system provides a set of one or more numbers that can be dialed and which numbers can be associated with delivery addresses to which communication is to be delivered when the corresponding number is dialed or used; and
plural different users of communications terminals can set-up their own associations between the numbers in the set of numbers that can be dialed and desired delivery addresses for the numbers.

34. The communications system of claim 32, further comprising:
a network system in communication with the communications terminal; and
a content services system in communication with the network system, the particular number connects a caller to the content services system via the network system, the content services system delivers communication to the associated delivery address.

35. The communications system of claim 32, wherein:
the controller allows the user of the communications terminal to associate an email address with a first number that can be dialed to establish a communications connection; and
the system further comprises means for enabling a call or message that is made or sent to the first number to be delivered by email to the email address that has been associated with the first number.

36. The communications system of claim 32, wherein:
the associated delivery address comprises an email address.

37. The communications system of claim 32, wherein:
the particular number that can be dialed can be associated with plural delivery addresses.

38. A communications apparatus, comprising:
means for storing associations between numbers that can be dialed using a communications terminal to establish a communications connection and delivery addresses to which communication is to be delivered when such a number is dialed or used; and
means for allowing a user of a communications terminal who intends to use a particular number that can be dialed to establish a communications connection to deliver a communication to an associated delivery address to establish an association between the particular number that can be dialed to establish a communications connection and a delivery address for that particular number.

39. The communications apparatus of claim 38, wherein:
the associated delivery address comprises an email address.

40. The communications apparatus of claim 38, wherein:
the particular number that can be dialed can be associated with plural delivery addresses.

41. A communications apparatus according to claim 38, further comprising:
means for enabling a call or message that is made to the particular number to be delivered to the delivery address, the means for allowing includes a controller.

42. A method of operating a communications system in which numbers that can be dialed using a communications terminal to establish a communications connection may be associated with delivery addresses to which communication can be delivered when such a number is dialed or used, the method comprising:
establishing an association between a number that can be dialed to establish a communications connection and a delivery address for that number, the establishing is performed by a user of a communications terminal who intends to use the number that can be dialed to establish a communications connection to deliver a communication to the associated delivery address.

43. The method of claim 42, wherein:
there is a set of plural numbers that can be dialed that can be used by plural different users simultaneously.

44. The method of claim 42, further comprising:
in response to the number that can be dialed and is associated with the delivery address, connecting to a system accessible via a communication infrastructure that is then operable to deliver communication to the associated delivery address.

45. The method of claim 42, wherein:
the establishing an association comprises associating the number that can be dialed with a delivery address that cannot be dialed directly using a communications terminal.

46. The method of claim 42, wherein:
the establishing an association comprises associating the number that can be dialed with an email address.

47. The method of claim 42, wherein:
the establishing an association comprises associating the number that can be dialed with plural delivery addresses.

48. The method of claim 42, wherein:
the establishing an association comprises associating the number to be dialed with a delivery address that is related to or associated with the user who is to dial the number.

49. The method of claim 42, further comprising:
sending a communication to the associated delivery address based on a request to transmit to the number.

50. The method of claim 42, further comprising:
sending a communication to an email address in response to a request to transmit to a telephone number, the email address is the associated delivery address, the telephone number is the number that can be dialed to establish a communications connection.

51. A processor readable storage device having processor readable code stored thereon, the processor readable code for programming a processor to perform a method comprising:
establishing an association between a number that can be dialed to establish a communications connection and a delivery address for that number.
